(19) United States
(12) Patent Application Publication
(10) Pub. No.: US 2025/0046211 A1
(43) Pub. Date: Feb. 6, 2025

(54) BEHAVIOR ASSISTANCE DEVICE, BEHAVIOR ASSISTANCE SYSTEM, AND BEHAVIOR ASSISTANCE METHOD

(71) Applicant: HITACHI, LTD., Chiyoda-ku, Tokyo (JP)

(72) Inventors: Hiroyuki YAMADA, Chiyoda-ku, Tokyo (JP); Yuto IMANISHI, Chiyoda-ku, Tokyo (JP); Go SAKAYORI, Chiyoda-ku, Tokyo (JP)

(73) Assignee: HITACHI, LTD., Chiyoda-ku, Tokyo (JP)

(21) Appl. No.: 18/718,531

(22) PCT Filed: Nov. 15, 2022
(86) PCT No.: PCT/JP2022/042389

§ 371 Date: Jun. 11, 2024

(30) Foreign Application Priority Data
Dec. 22, 2021 (JP) 2021-208643

(51) Int. Cl. G09B 19/00; G06Q 10/0639; G06V 40/20

(52) U.S. Cl. CPC G09B 19/00; G06Q 10/06398; G06V 40/20

(57) ABSTRACT

The present disclosure provides a behavior assistance device which improves the autonomy and skill level of a person in question and assists in the behavior of the person in question, so as to prevent a degradation in overall efficiency even when the assistance for the behavior of the person in question is no longer available. A behavior assistance device, which assists in the behavior of a person in question according to the surrounding environment of the person in question, comprises a learning unit, a prediction unit, and a behavior assistance unit. The learning unit learns environmental information pertaining to the environment and behavioral information pertaining to the behavior of the person in question for the environment, and generates a behavior model of the person in question. The prediction unit generates a prediction behavior of the person in question on the basis of the behavior model and the environmental information. The behavior assistance unit generates behavior assistance information for the person in question according to a matching degree between an optimal behavior of the person in question based on the environmental information and the prediction behavior of the person in question.

### TECHNICAL FIELD

The present disclosure relates to a behavior support apparatus, a behavior support system, and a behavior support method.

### BACKGROUND ART

Conventionally, a guidance program for providing guidance information to an object person and accurately guiding the object person is known. A guidance management program described in the following Patent Literature 1 includes transceiver means and reversible printing means (the same literature, claim 5 and the like). The transceiver means and the reversible printing means perform reversible printing on a reversible display part of an information display medium including the reversible display part on which information is visually reversibly displayed, and data storage means, and transmit and receive data to and from the data storage means.

This conventional guidance management program manages guidance of the object person by using behavior schedule storage means and a management computer connected to guidance data storage means. In this case, the behavior schedule storage means is a node terminal installed in a node, or means for recoding behavior schedule data regarding the object person. In addition, the guidance data storage means is means for recording guidance data for guiding the object person to a node to which the object person moves next. This conventional guidance management program causes the management computer to function as node identifying means, acquiring means, and output means.

The node identifying means acquires behavior identification data recorded in the data storage means of the information display medium via the node terminal, and identifies a node to which the object person moves next from the behavior schedule storage means based on this behavior identification data. The acquiring means acquires, from the guidance data storage means, guidance data for guiding from a node in which reversible printing means of the node terminal is installed to a node to which the object person moves next. The output means displays the acquired guidance data on the reversible display part of the information display medium via the node terminal.

According to the conventional guidance management program, it is possible to guide the object person to the next node by guidance printed on the reversible display part of the information display medium. Therefore, for example, the object person is guided sequentially to nodes closer to a final destination, and thus it is possible to accurately guide the object person. In addition, every time the object person arrives at a node, the target is guided to the next node. Therefore, the management computer can recognize progress of the object person at each node and manage a behavioral process of the object person (Patent Literature 1, paragraph 0011 and the like).

### CITATION LIST

### Patent Literature

Patent Literature 1: Japanese Unexamined Patent Application Publication No. 2006-126173

### SUMMARY OF INVENTION

### Technical Problem

The above-described conventional guidance management program sequentially guides the object person to nodes closer to the final destination and thus can accurately guide the object person. However, the object person relies too much on the guidance and thus the conventional guidance management program may reduce the autonomy of the object person and reduce the familiarity of the object person. Therefore, for example, when a failure occurs in the guidance management program, the object person may not be able to take an appropriate behavior in accordance with an environment around the object person and the overall efficiency may decrease.

The present disclosure provides a behavior support apparatus, a behavior support system, and a behavior support method that can improve the autonomy and familiarity of an object person and support a behavior of the target person to prevent a decrease in the overall efficiency even when the support for the behavior of the object person is not provided.

### Solution to Problem

An aspect of the present disclosure is a behavior support apparatus that supports a behavior of an object person in accordance with an environment around the object person and includes: a learning unit that learns environment information regarding the environment and behavior information regarding a behavior of the object person with respect to the environment and generates a behavior model for the object person; a predicting unit that generates a predicted behavior of the object person based on the behavior model and the environment information; and a behavior support unit that generates behavior support information for the object person in accordance with a degree of coincidence between an optimal behavior of the object person based on the environment information and the predicted behavior of the object person.

### Advantageous Effects of Invention

According to the above-described aspect of the present disclosure, the behavior support apparatus that can improve the autonomy and familiarity of an object person and support a behavior of the target person to prevent a decrease in the overall efficiency even when the support for the behavior of the object person is not provided.

### BRIEF DESCRIPTION OF DRAWINGS

FIG. 1 is a block diagram illustrating an embodiment of a behavior support apparatus and a behavior support system according to the present disclosure.

FIG. 2 is a perspective view illustrating an example of an environment around an object person supported by a behavior support apparatus illustrated in FIG. 1.

FIG. 3 is a plan view illustrating movement routes of moving objects in the environment illustrated in FIG. 2.

FIG. 4 is a flowchart illustrating an embodiment of a behavior support method according to the present disclosure.

FIG. 5 is a flowchart illustrating details of a step of acquiring environment information around the object person in FIG. 4.

FIG. 6 is a flowchart illustrating details of a step of acquiring behavior information of the object person in FIG. 4.

FIG. 7 is a flowchart illustrating details of a step of generating a behavior model for the object person in FIG. 4.

FIG. 8 is a flowchart illustrating details of a step of generating a predicted behavior of the object person in FIG. 4.

FIG. 9 is a flowchart illustrating details of a step of generating behavior support information for the object person in FIG. 4.

FIG. 10 is a flowchart illustrating details of a step of providing the behavior support information to the object person in FIG. 4.

FIG. 11 is an image diagram illustrating an example of behavior support information provided by a UI illustrated in FIG. 1 to the object person.

FIG. 12 is an image diagram illustrating an example of behavior support information provided by the UI illustrated in FIG. 1 to the object person.

FIG. 13 is an image diagram illustrating an example of behavior support information provided by the UI illustrated in FIG. 1 to the object person.

FIG. 14 is an image diagram illustrating an example of behavior support information provided by the UI illustrated in FIG. 1 to the object person.

### DESCRIPTION OF EMBODIMENTS

Hereinafter, embodiments of a behavior support apparatus, a behavior support system, and a behavior support method will be described with reference to the drawings.

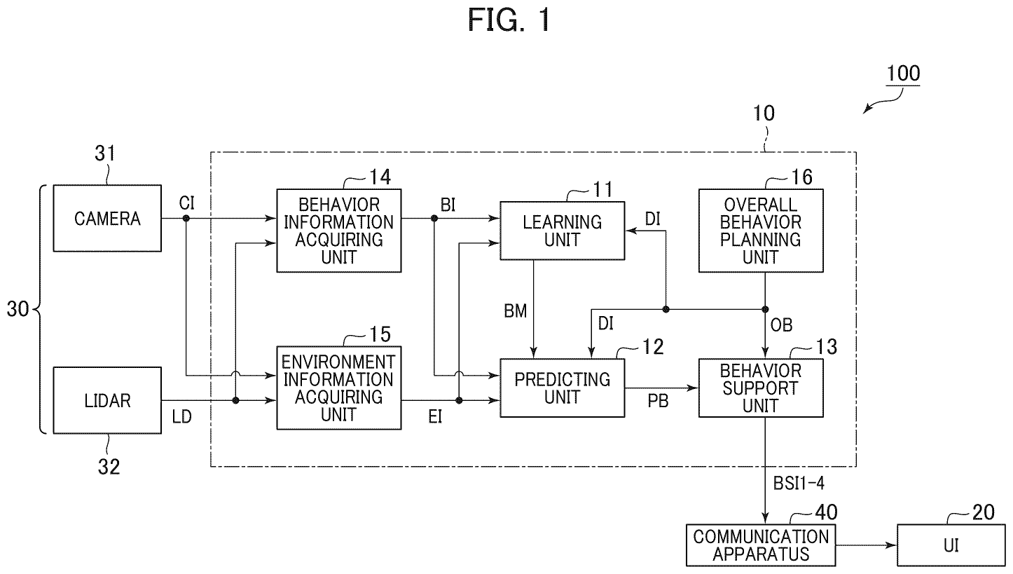

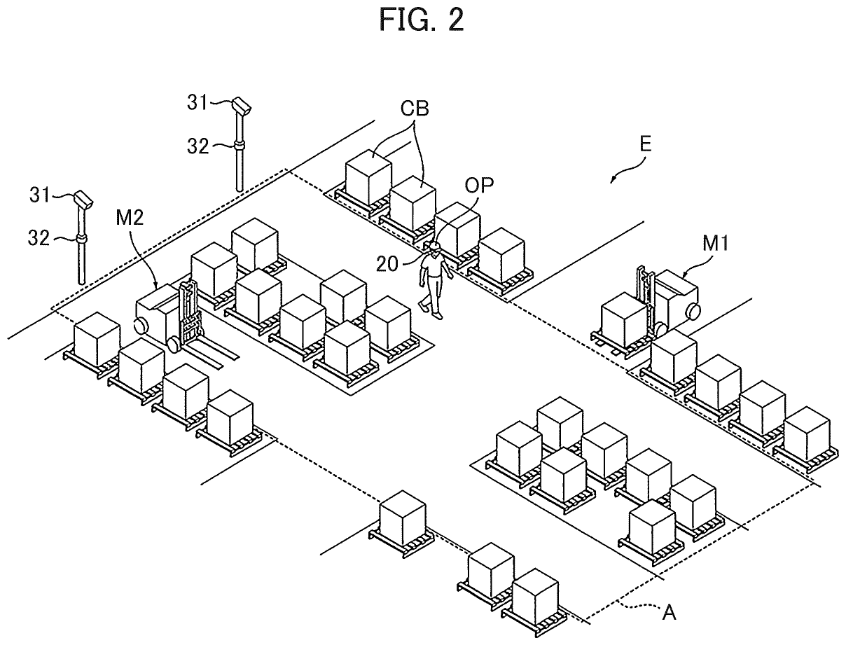

FIG. 1 is a block diagram illustrating an embodiment of a behavior support apparatus and a behavior support system according to the present disclosure. FIG. 2 is a perspective view illustrating an example of an object person OP whose behavior is supported by a behavior support apparatus 10 and a behavior support system 100 illustrated in FIG. 1, and an environment E around the object person.

The behavior support apparatus 10 according to the present embodiment is an apparatus that supports a behavior of the object person OP in accordance with the environment E around the object person OP and generates behavior support information BSI1 to BSI4 for the object person OP. The environment E is, for example, an environment such as a logistics warehouse in which autonomous machines M1, M2, - - - , such as unmanned forklifts that autonomously travel, and a worker who is the object person OP concurrently perform work in the same space.

The behavior support system 100 according to the present embodiment includes the behavior support apparatus 10 and a user interface (UI) 20 that provides behavior support information generated by the behavior support apparatus 10 to the object person OP. In addition, the behavior support system 100 may include, for example, an external sensor 30 and a communication apparatus 40.

The behavior support apparatus 10 is an apparatus that supports a behavior of the object person OP in accordance with the environment E around the object person OP. The behavior support apparatus 10 can be constituted by, for example, one or more microcontrollers having a central processing unit (CPU), memories such as a RAM and a ROM, a timer, and an input/output unit, firmware, or a computer.

The behavior support apparatus 10 includes, for example, a learning unit 11, a predicting unit 12, and a behavior support unit 13. The behavior support apparatus 10 may further include, for example, a behavior information acquiring unit 14, an environment information acquiring unit 15, and an overall behavior planning unit 16. The behavior information acquiring unit 14, the environment information acquiring unit 15, and the overall behavior planning unit 16 may be installed in an apparatus different from the behavior support apparatus 10.

Each of the components of the behavior support apparatus 10 illustrated in FIG. 1, for example, represents each of functions of the behavior support apparatus 10 implemented by the CPU executing a program recorded in a memory. The components of the behavior support apparatus 10 illustrated in FIG. 1 may be installed in different apparatuses. Two or more components of the behavior support apparatus 10 illustrated in FIG. 1 may be installed in the same apparatus. All the components of the behavior support apparatus 10 illustrated in FIG. 1 may be installed in one apparatus.

The UI 20 is, for example, augmented reality (AR) glasses or smart glasses that can be worn by the object person OP. For example, the UI 20 receives behavior support information BSI1 to BSI4 transmitted from the behavior support apparatus 10 via the communication apparatus 40 and displays the behavior support information BSI1 to BSI4 in a field of view of the object person OP without largely blocking the field of view of the object person OP to provide the behavior support information BSI1 to BSI4 to the object person OP. The UI 20 is not limited to the smart glasses and may be, for example, a mobile information terminal such as a smartphone or an apparatus that is a digital signage, a projector, or the like and displays information in the environment E around the object person OP.

The external sensor 30 includes, for example, at least either one or more cameras 31 or one or more LiDARs 32. The external sensor 30 detects, for example, in an application area A set in the environment E, external information indicating the positions, speeds, and movement directions of the object person OP and the autonomous machines M1, M2, - - - , and indicating whether a container box CB is present, and outputs the detected external information to the behavior support apparatus 10. In the example illustrated in FIG. 2, two cameras 31 and two LiDARs 32 are disposed adjacent to the application area A.

The communication apparatus 40 is, for example, a wireless communication apparatus that can wirelessly communicate with the UI 20. The communication apparatus 40, for example, is capable of information communication and connected to the behavior support apparatus 10 via a wired communication line or a wireless communication line and receives behavior support information BSI1 to BSI4 for the object person OP from the behavior support apparatus 10. For example, the communication apparatus 40 transmits the behavior support information BSI1 to BSI4 received from the behavior support apparatus 10 to the UI 20 via the wireless communication line.

Operations of the behavior support apparatus 10 and the behavior support system 100 according to the present embodiment will be described below.

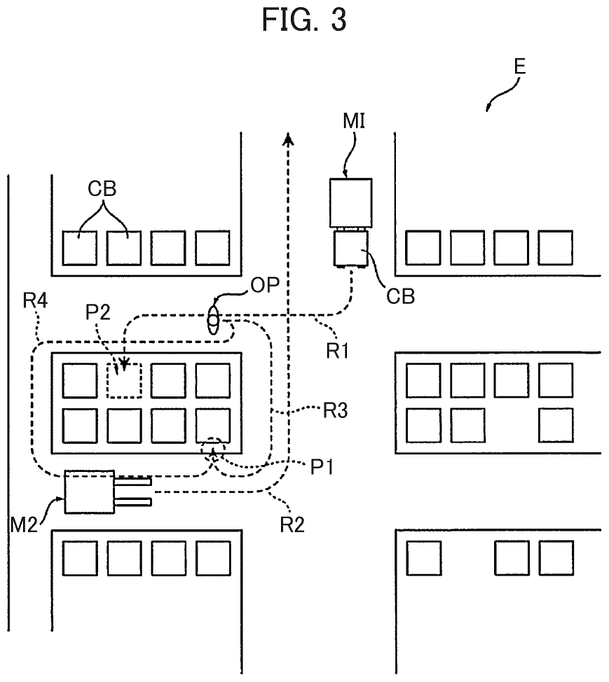

FIG. 3 is a plan view illustrating movement routes R1 to R4 of the autonomous machines M1 and M2 and the target OP that are moving objects in the environment E illustrated in FIG. 2. For example, the overall behavior planning unit 16 illustrated in FIG. 1 optimizes behaviors of object persons OP such as a plurality of workers and behaviors of the autonomous machines M1 and M2 such as a plurality of forklifts, calculates the movement routes R1, R2, and R4 such that the overall efficiency is as high as possible, and assigns tasks to each of the object persons OP and the autonomous machines M1 and M2.

More specifically, the overall behavior planning unit 16 generates the movement routes R1 and R2 of the respective autonomous machines M1 and M2 traveling in the environment E2 such as a logistics warehouse based on, for example, an order, and transmits the generated movement routes R1 and R2 to the respective autonomous machines M1 and M2 via the communication apparatus 40. The autonomous machines M1 and M2 autonomously travel along the movement routes R1 and R2 received via the wireless communication line, respectively. In addition, the overall behavior planning unit 16 generates, for example, an optimal behavior OB including optimal movement routes R4 of the object persons OP based on environment information EI regarding the environment E around the object persons OP.

In addition, for example, the overall behavior planning unit 16 assigns tasks to the respective object persons OP and transmits information of the assigned tasks to the UI 20 and mobile information terminals (not illustrated) of the object persons OP via the communication apparatus 40. The object persons OP, for example, perform work in accordance with the tasks displayed on the UI 20 and the mobile information terminals. In a case where a task assigned to an object person OP includes a movement to a location P1 in the environment E for example, the object person OP starts to move to the location P1 in accordance with the task displayed on the UI 20 and a mobile information terminal.

The shortest route from the current position of the object person OP illustrated in FIG. 3 to the location P1 is a movement route R3. However, when the object person OP moves along the movement route R3, the object person OP may obstruct the paths of the autonomous machines M1 and M2 moving along the movement routes R1 and R2, respectively, anti-collision functions of the autonomous machines M1 and M2 may be activated to cause the autonomous machines M1 and M2 to make an emergency stop or the like, and the overall efficiency of the tasks in the environment E may decrease.

In such a case, the object person OP familiar with the environment E, that is, the object person OP highly familiar with experience in the environment E, for example, can predict the movement routes R1 and R2 of the autonomous machines M1 and M2 from the information regarding the environment E around the object person OP. The information regarding the environment E around the object person OP can indicate the movement direction of the autonomous machine M1 carrying the container box CB, an intersection that is a branch point on the path on which the autonomous machine M1 travels, a location P2 at which the container box CB is not placed, the movement direction of the autonomous machine M2 after the container box CB is placed, and the like.

In the environment E as illustrated in FIG. 3, to move to the location P1, the object person OP familiar with the environment E moves along the movement route R4 to avoid obstructing the paths of the autonomous machines M1 and M2, instead of the movement route R3 that is the shortest route, in order to prevent a decrease in the overall efficiency in the environment E. As a result, it is possible to prevent the autonomous machines M1 and M2 from making an emergency stop and to prevent a decrease in the overall efficiency in the environment E. However, not all the object persons OP may be familiar with the environment E and thus it is necessary to support a behavior of an object person OP.

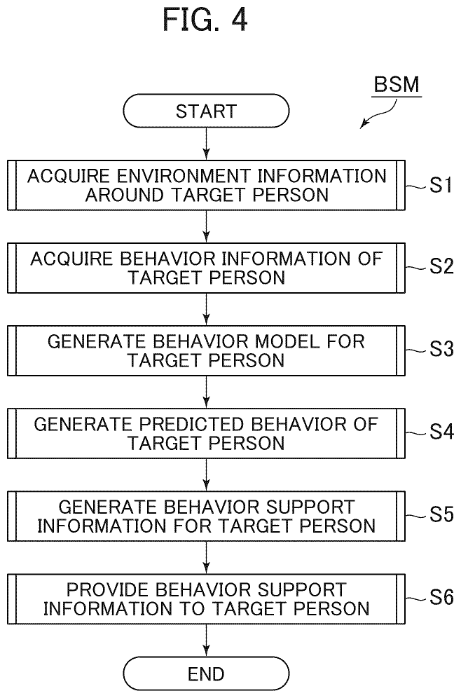

FIG. 4 is a flowchart illustrating an embodiment of the behavior support method according to the present disclosure. A behavior support method BSM according to the present embodiment can be performed by, for example, the behavior support system 100 illustrated in FIG. 1. The behavior support method BSM according to the present embodiment includes, for example, step S1 of acquiring the environment information EI regarding the environment E around the object person OP and step S2 of acquiring behavior information BI regarding a behavior of the object person OP with respect to the environment E around the object person OP.

The behavior support method BSM according to the present embodiment further includes, for example, step S3 of learning the environment information EI and the behavior information BI by machine learning to generate a behavior model BM for the object person OP, and step S4 of generating a predicted behavior PB of the object person OP based on the behavior model BM and the environment information EI. The behavior support method BSM according to the present embodiment further includes, for example, step S5 of generating behavior support information BSI1 to BSI4 for the object person OP in accordance with a degree of coincidence DC between an optimal behavior OB of the object person OP based on the environment information EI and the predicted behavior PB of the object person OP. The behavior support method BSM according to the present embodiment further includes, for example, step S6 of providing the behavior support information BSI1 to BSI4 to the object person OP.

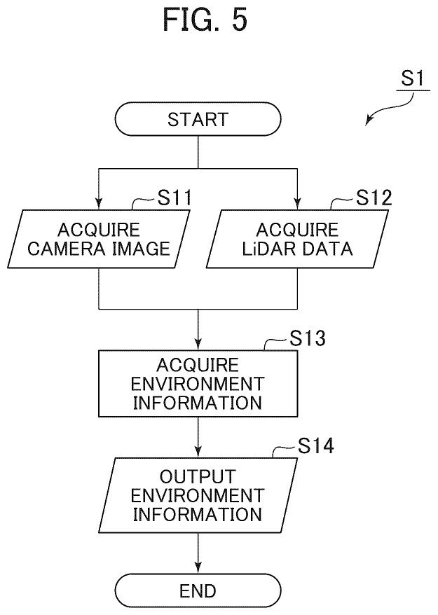

The behavior support apparatus 10 according to the present embodiment repeatedly performs step S1 to S6 illustrated in FIG. 4, for example, at a predetermined interval. Details of step S1 to S6 illustrated in FIG. 4 and operations of the behavior support apparatus 10 and the behavior support system 100 in steps S1 to S6 will be described with reference to FIGS. 5 to 14.

FIG. 5 is a flowchart illustrating details of step S1 of acquiring the environment information in FIG. 4. For example, when starting step S1 illustrated in FIG. 5, the behavior support apparatus 10 of the behavior support system 100 illustrated in FIG. 1 performs steps S11 and S12 of acquiring camera images CI and LiDAR data LD from the cameras 31 and the LiDARs 32. More specifically, the environment information acquiring unit 15 of the behavior support apparatus 10 acquires the camera images CI including an image of the environment E around the object person OP from the plurality of cameras 31 in step S11, and acquires the LiDAR data LD including point cloud data of the environment E around the object person OP from the plurality of LiDARs 32 in step S12.

Next, the environment information acquiring unit 15 performs, for example, step S13 of acquiring the environment information EI regarding the environment E around the object person OP from the camera images CI and the LiDAR data LD. In this step S13, for example, the environment information acquiring unit 15 extracts point cloud data of the autonomous machines M1, M2, - - - , which are moving objects, from LiDAR data LD by background differencing, and estimates the positions of the autonomous machines M1, M2, - - - - In addition, in this step S13, for example, the environment information acquiring unit 15 applies semantic segmentation to the camera images CI of the application area A of the environment E and classifies objects in the application area A into categories such as the paths, the container box CB, and the autonomous machines M1, M2, - - - -

Therefore, the environment information acquiring unit 15 can acquire, for example, the environment information EI including the estimated positions of the autonomous machines M1, M2, - - - , and the categories of the objects in the application area A. Thereafter, the environment information acquiring unit 15 performs step S14 of outputting the acquired environment information EI to the learning unit 11 and the predicting unit 12 and ends step S1 illustrated in FIG. 5.

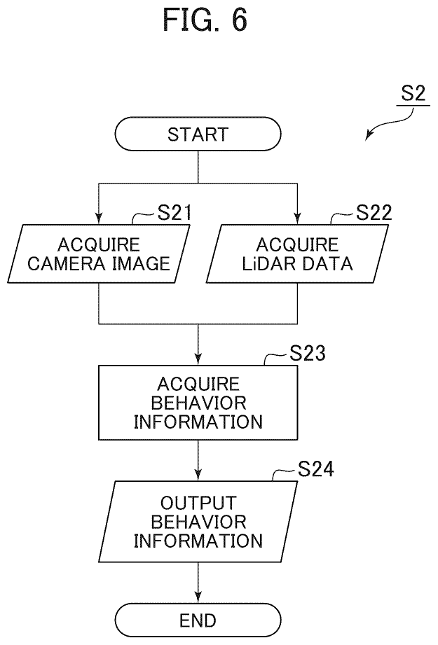

FIG. 6 is a flowchart illustrating details of step S2 of acquiring the behavior information BI of the object person OP in FIG. 4. For example, when starting step S2 illustrated in FIG. 6, the behavior support apparatus 10 that constitutes the behavior support system 100 performs steps S11 and S12 of acquiring the camera images CI and the LiDAR data LD from the cameras 31 and the LiDAR 32 illustrated in FIGS. 1 and 2. More specifically, the behavior information acquiring unit 14 of the behavior support apparatus 10 acquires the camera images CI including an image of the object person OP from the plurality of cameras 31 in step S21 and acquires the LiDAR data LD including point cloud data of the object person OP from the plurality of LiDARs 32 in step S22.

Next, the behavior information acquiring unit 14 performs, for example, step S23 of acquiring the behavior information BI regarding the behavior of the object person OP from the camera images CI and the LiDAR data LD. In this step S23, the behavior information acquiring unit 14 tracks, for example, the movement route of the object person OP. More specifically, the behavior information acquiring unit 14 identifies, for example, the object person OP from the camera images CI including the image of the object person OP and grasps a rough position of the object person OP.

In addition, for example, the behavior information acquiring unit 14 extracts point cloud data of moving objects including the object person OP from the LiDAR data LD by background differencing, extracts point cloud data of the object person OP from the rough position of the object person OP based on the camera images CI, and estimates a detailed position of the object person OP. Therefore, for example, the behavior information acquiring unit 14 can acquire the behavior information BI including the movement route of the object person OP. Thereafter, the behavior information acquiring unit 14 performs step S24 of outputting the acquired behavior information BI to the learning unit 11 and the predicting unit 12 and ends step S2 illustrated in FIG. 6.

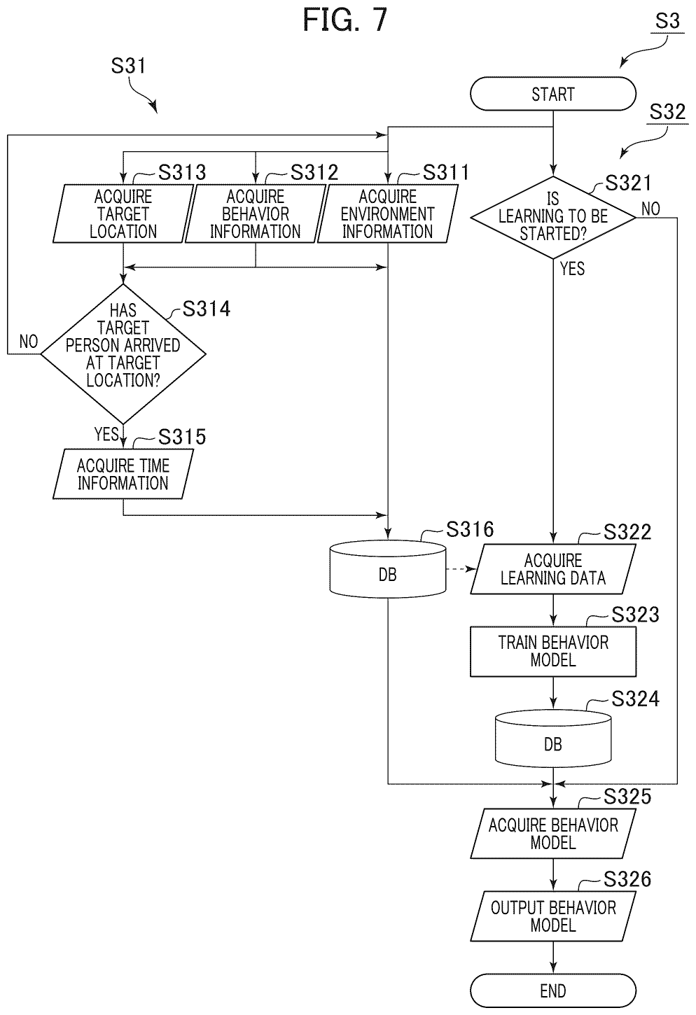

FIG. 7 is a flowchart illustrating details of step S3 of generating the behavior model BM for the object person OP in FIG. 4. In this step S3, the behavior support apparatus 10 of the behavior support system 100 learns the environment information EI regarding the environment E and the behavior information BI regarding the behavior of the object person OP with respect to the environment E by machine learning and generates the behavior model BM for the object person OP. When starting step S3 illustrated in FIG. 7, the behavior support apparatus 10 performs learning data collection step S31 and learning step S32 in parallel, for example.

In learning data collection step S31, the learning unit 11 of the behavior support apparatus 10 performs steps S311 to S316, for example. First, the learning unit 11 performs step S311 of acquiring the environment information EI around the object person OP from the environment information acquiring unit 15, step S312 of acquiring the behavior information BI of the object person OP from the behavior information acquiring unit 14, and step S313 of acquiring destination information DI of the object person OP from the overall behavior planning unit 16.

In addition, the learning unit 11 performs step S314 of comparing position information of the object person OP included in the behavior information BI of the object person OP acquired in step S312 with the destination information DI of the object person OP acquired in step S313 and determining whether or not the object person OP has arrived at a destination. In this step S314, for example, in a case where the difference between the position information of the object person OP and the destination information DI of the object person OP, that is, the distance between the position of the object person OP and the destination is larger than a predetermined threshold, the learning unit 11 determines that the object person OP has not arrived at the destination (No). In this case, the learning unit 11 repeats steps S311 to S314 again.

On the other hand, in step S314, in a case where the difference between the position information of the object person OP and the destination information DI of the object person OP, that is, the distance between the position of the object person OP and the destination is smaller than or equal to the predetermined threshold, the learning unit 11 determines that the object person OP has arrived at the destination (Yes). In this case, the learning unit 11 performs step S315 of acquiring information of the time when the object person OP has arrived at the destination. In addition, for example, the learning unit 11 performs step S316 of dividing the time series of the environment information EI acquired in step S311 and the behavior information BI acquired in step S312 by the arrival time of the object person OP at the destination acquired in step S315, and storing the result of the division in a database.

By this step S316, for example, the learning unit 11 can associate the environment information EI with the behavior information BI for a time period for which the object person OP moves from a previous destination to the current destination, and store the result of the association as a single episode log in the database. As a result, it is possible to use the behavior information BI including a movement route from the previous destination of the object person OP to the current destination of the object person OP, and the environment information EI around the object person OP for a time period for which the object person OP moves along the movement route.

In parallel with the above-described learning data collection step S31, the learning unit 11 performs learning step S32. In learning step S32, first, the learning unit 11 performs step S321 of determining whether or not to start machine learning. In this step S321, for example, in a case where the amount of data of an episode log accumulated in the database is smaller than a predetermined level, or when a predetermined time (for example, approximately 1 hour) set in advance has not elapsed, the learning unit 11 determines not to start the learning (No).

In this case, the learning unit 11 performs step S325 of acquiring the behavior model BM without performing step S322 of acquiring learning data, step S323 of training the behavior model BM, and step S324 of storing a parameter of the behavior model BM to the database.

On the other hand, for example, in a case where the amount of the episode log accumulated in the database exceeds the predetermined level, or when the predetermined time (for example, approximately 1 hour) set in advance has elapsed, the learning unit 11 determines to start the learning (Yes). Therefore, the learning unit 11 can perform step S322 of acquiring the learning data and efficiently perform the machine learning in a state in which an episode log with a data amount larger than or equal to the predetermined level is accumulated in the database.

In step S322, the learning unit 11 acquires, from the database, the episode log accumulated in the database in the above-described learning data collection step S31. As described above, the episode log is information in which the environment information EI around the object person OP and the behavior information BI of the object person OP for the time period for which the object person OP moves from the previous destination to the current destination are associated with each other. In addition, the learning unit 11 performs step S323 of generating the behavior model BM, which is provided for predicting a behavior of the object person OP with respect to the environment information EI around the object person, by machine learning using the acquired episode log.

In this case, the behavior model BM generated by the learning unit 11 is, for example, a model to which information of a start location included in the behavior information BI of the object person OP, the destination information DI of the object person OP, the environment information EI around the object person OP are input, and from which a predicted movement route of the object person OP is output. The behavior model BM for the object person OP can be built by, for example, a method such as deep learning.

That is, the learning unit 11 extracts the information of the start location of the object person OP, the destination information DI, and the environment information EI from the episode log in step S323. Furthermore, the learning unit 11 gives, as teacher data, the movement route of the object person OP in the episode log to the behavior model BM and performs machine learning on the behavior model BM. Thereafter, the learning unit 11 performs step S324 of storing, to the database, a new parameter of the behavior model BM subjected to the machine learning, and updating an old parameter of the behavior model BM stored in the database to the new parameter.

As described above, in learning step S32, the learning unit 11 learns the environment information EI regarding the environment E and the behavior information BI regarding the behavior of the object person OP with respect to the environment E, and generates the behavior model BM for the object person OP. Thereafter, the learning unit 11 performs step S325 of acquiring the behavior model BM from the database and step S326 of outputting the behavior model BM to the predicting unit 12, and ends step S3 illustrated in FIG. 7.

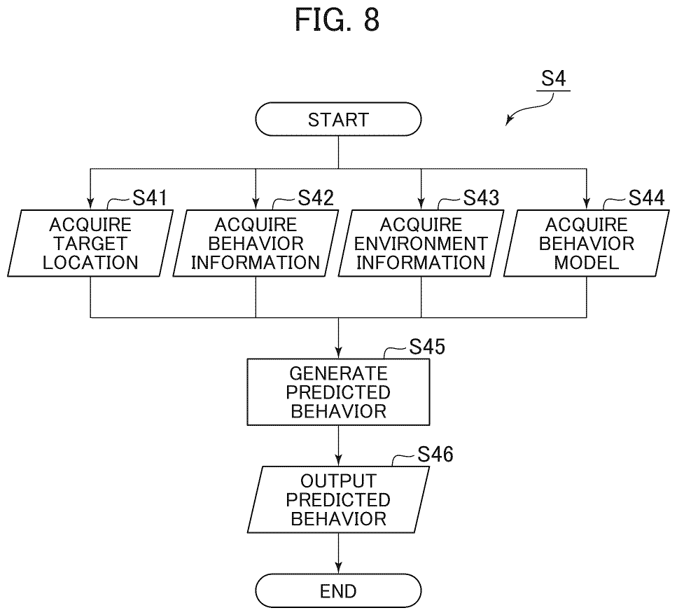

FIG. 8 is a flowchart illustrating details of step S4 of generating the predicted behavior PB of the object person OP in FIG. 4. In this step S4, the predicting unit 12 of the behavior support apparatus 10 illustrated in FIG. 1 generates the predicted behavior PB of the object person OP based on the behavior model BM and the environment information EI.

More specifically, when step S4 illustrated in FIG. 8 is started, the predicting unit 12 performs, for example, step S41 of acquiring the destination information DI regarding the destination of the object person OP from the overall behavior planning unit 16, and step S42 of acquiring the behavior information BI regarding the behavior of the object person OP from the behavior information acquiring unit 14. In addition, in parallel with these steps, the predicting unit 12 performs step S43 of acquiring the environment information EI regarding the environment E around the object person OP from the environment information acquiring unit 15, and step S44 of acquiring the behavior model BM for the object person OP from the learning unit 11.

Next, the predicting unit 12 performs step S45 of inputting the position information of the object person OP included in the behavior information BI of the object person OP, the destination information DI of the object person OP, and the environment information EI around the object person OP to the behavior model BM and generating the predicted behavior PB of the object person OP as output of the behavior model BM. The predicted behavior PB of the object person OP, for example, includes the movement route of the object person OP predicted based on a past behavior of the object person OP with respect to the environment E around the object person OP. Thereafter, the predicting unit 12 performs step S46 of outputting the generated predicted behavior PB to the behavior support unit 13, and ends step S4 illustrated in FIG. 8.

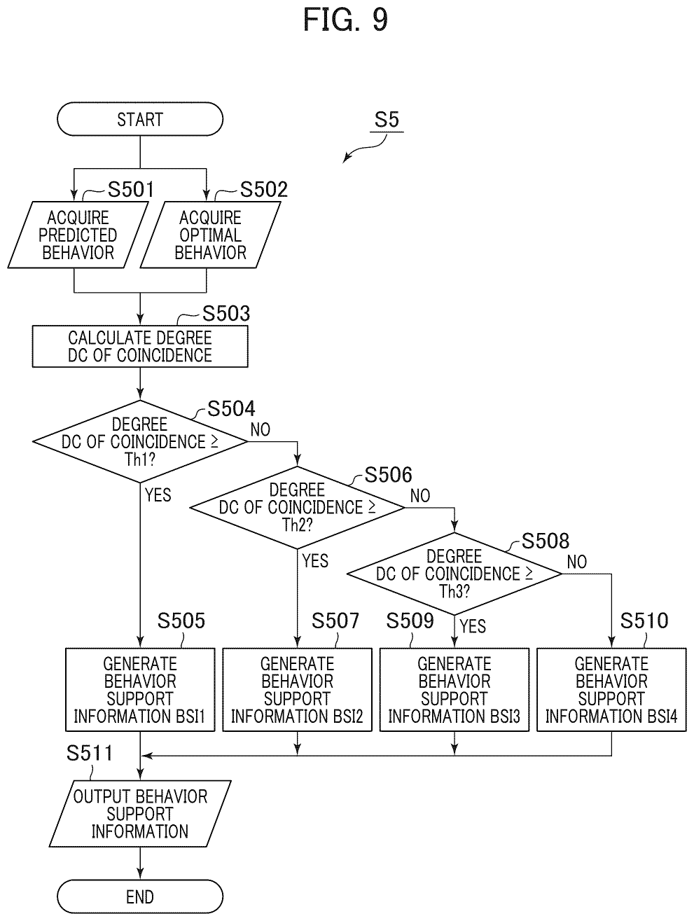

FIG. 9 is a flowchart illustrating details of step S5 of generating the behavior support information BSI1 to BSI4 for the object person OP in FIG. 4. In this step S5, for example, the behavior support unit 13 of the behavior support apparatus 10 illustrated in FIG. 1 generates the behavior support information BSI1 to BSI4 for the object person OP in accordance with a degree of coincidence DC between the optimal behavior OB of the object person OP based on the environment information EI and the predicted behavior PB of the object person OP.

More specifically, when step S5 illustrated in FIG. 9 is started, the behavior support unit 13 performs step S501 of acquiring the predicted behavior PB of the object person OP from the predicting unit 12 and step S502 of acquiring the optimal behavior OB based on the environment information EI around the object person OP from the overall behavior planning unit 16. Next, the behavior support unit 13, for example, performs step S503 of calculating the degree of coincidence DC between the predicted behavior PB of the object person OP and the optimal behavior OB of the object person OB.

The degree of coincidence DC can be calculated based on a percentage at which a plurality of indicators, such as an indicator indicating that the person moves in the same direction along the same path from the start location, and an indicator indicating that paths branches in the same direction at a branch point where the paths intersect each other. For example, in a case where the predicted behavior PB and the optimal behavior OP completely match, the degree of coincidence DC may be 100%. As the number of points where the predicted behavior PB and the optimal behavior OP are different increases, the degree of coincidence DC may decrease. In addition, the degree of coincidence DC, for example, may be increased as the difference between movement speeds of the object person OP that are included in the predicted behavior PB and the optimal behavior OP decreases. In addition, the degree of coincidence DC may be reduced as the difference between the overall efficiency in the environment E with respect to the optimal behavior OP of the object person OP and the overall efficiency in the environment E with respect to the predicted behavior PB of the object person OP increases.

Next, the behavior support unit 13, for example, performs step S504 of determining whether or not the degree of coincidence DC calculated in step S503 is larger than or equal to a first threshold Th1. In this step S504, for example, in a case where the first threshold Th1 is set to 100%, it is determined whether or not a movement route included in the predicted behavior PB of the object person OP completely matches a movement route included in the optimal behavior OB of the object person OP. The first threshold Th1 may be set to a value less than 100%.

In a case where the behavior support unit 13 determines that the degree of coincidence DC is equal to or larger than the first threshold Th1 in step S504 (Yes), for example, the movement route included in the predicted behavior PB of the object person OP completely matches the movement route included in the optimal behavior OB of the object person OP in step S504, the behavior support unit 13 performs step S505 of generating the first behavior support information BSI1. The first behavior support information BSI1 generated in this step S505 is information in which the predicted behavior PB matches or substantially matches the optimal behavior OB and which is provided to the object person OP completely familiar with the environment E.

Therefore, the first behavior support information BSI1 generated in step S505 is the simplest information among the behavior support information BSI1 to BSI4 generated by the behavior support unit 13. For example, as described above, in a case where it is determined that the predicted behavior PB of the object person OP matches the optimal behavior OB of the object person OP in step S504 (Yes), step S5 illustrated in FIG. 9 may be ended without the generation of the behavior support information BSI1 to BSI4. That is, in a case where the degree of coincidence DC between the optimal behavior OB of the object person OP and the predicted behavior PB of the object person OP exceeds a predetermined threshold, the behavior support unit 13 may not generate the behavior support information BSI1 to BSI4.

On the other hand, in a case where the behavior support unit 13 determines that the degree of coincidence DC is less than the first threshold Th1 in the above-described step S504 (No), for example, determines that the predicted behavior PB and the optimal behavior OB of the object person OP do not match, the behavior support unit 13 performs the next step S506. In this step S506, the behavior support unit 13, for example, determines whether or not the degree of coincidence DC is equal to or larger than a second threshold Th2. The second threshold Th2 for the degree of coincidence DC is, for example, set to a lower value than the first threshold Th1 for the degree of coincidence DC.

In a case where the behavior support unit 13 determines that the degree of coincidence DC is equal to or larger than the second threshold Th2 in step S506 in step S506 (Yes), the behavior support unit 13 performs step S507 of generating the second behavior support information BSI2. The second behavior support information BSI2 generated in this step S507 is information that is provided to the object person OP who has some experience with the environment E and is relatively familiar with the environment E.

Therefore, the second behavior support information BSI2 generated in this step S507 is the second simplest information after the first behavior support information BSI1 among the behavior support information BSI1 to BSI4 generated by the behavior support unit 13. In other words, the second behavior support information BSI2 generated in this step S507 is made simpler than the third behavior support information BSI3 and the fourth behavior support information BSI4 described later, but is information that is more detailed than the simplest first behavior support information BSI1.

On the other hand, in a case where the behavior support unit 13 determines that the degree of coincidence DC is less than the second threshold Th2 in the above-described step S506 (No), the behavior support unit 13 performs the next step S508. In this step S508, for example, the behavior support unit 13 determines whether or not the degree of coincidence DC is equal to or larger than a third threshold Th3. In this case, the third threshold Th3 for the degree of coincidence DC is, for example, set to a lower value than the second threshold Th2.

In a case where the behavior support unit 13 determines that the degree of coincidence DC is equal to or larger than the third threshold Th3 in step S508 (Yes), the behavior support unit 13 performs step S509 of generating the third behavior support information BSI3. The third behavior support information BSI3 generated in this step S509 is information that is provided to the object person OP who lacks experience with the environment E and is not very familiar with the environment E.

Therefore, the third behavior support information BSI3 generated in this step S509 is, for example, information that is more detailed than the second behavior support information BSI2. However, the object person OP to whom the third behavior support information BSI3 is provided has some experience with the environment E, for example. Therefore, the third behavior support information BSI3 is, for example, simpler information than the most detailed fourth behavior support information BSI4 described later.

On the other hand, in a case where the behavior support unit 13 determines that the degree of coincidence DC is less than the third threshold Th3 in the above-described step S508 (No), the behavior support unit 13 performs step S510 of generating the fourth behavior support information BSI4. The fourth behavior support information BSI4 generated in this step S509 is, for example, information that is provided to the object person OP who has little experience with the environment E and is not familiar with the environment E at all. Therefore, the fourth behavior support information BSI4 generated in this step S510 is, for example, the most detailed information among the behavior support information BSI1 to BSI4.

Thereafter, the behavior support unit 13 performs step S511 of outputting, to the communication apparatus 40 illustrated in FIG. 1, any of the first to fourth behavior support information BSI1 to BSI4 generated in the above-described step S505, S507, S509, or S510, for example and ends step S5 illustrated in FIG. 9. For example, the communication apparatus 40 transmits, to the UI 20 via the wireless communication line, the behavior support information BSI1 to BSI4 input from the behavior support unit 13.

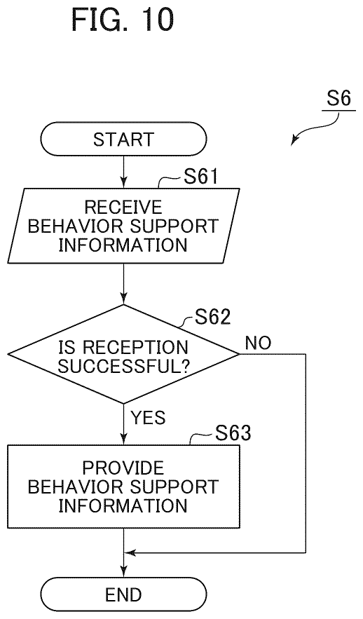

FIG. 10 is a flowchart illustrating details of step S6 of providing the behavior support information BSI1 to BSI4 to the object person OP in FIG. 4. When step S6 illustrated in FIG. 10 is started, the UI 20 of the behavior support system 100 illustrated in FIG. 1 performs step S61 of receiving the behavior support information BSI1 to BSI4 transmitted from the behavior support apparatus 10 via the communication apparatus 40. Next, the UI 20 performs step S62 of determining whether or not the UI 20 has successfully received the behavior support information BSI1 to BSI4.

For example, in a case where the UI 20 determines that the reception of the behavior support information BSI1 to BSI4 has failed in this step S62 (No), the UI 20 ends step S6 illustrated in FIG. 6 without performing step S63 of providing the behavior support information BSI1 to BSI4 to the object person OP. Thereafter, the behavior support system 100 ends the behavior support method BSM illustrated in FIG. 4 and repeatedly performs steps S1 to S6 of the behavior support method BSM illustrated in FIG. 4 at the predetermined interval.

In this case, the UI 20 may notify the object person OP that the reception of the behavior support information BSI1 to BSI4 has failed. In addition, the UI 20 may repeat step S61 of receiving the behavior support information BSI1 to BSI4 until the UI 20 successfully receives any of the behavior support information BSI1 to BSI4. On the other hand, for example, in a case where the UI 20 determines that the UI 20 has successfully received any of the behavior support information BSI1 to BSI4 in the above-described step S62 (Yes), the UI 20 performs step S63 of providing the received information among the behavior support information BSI1 to BSI4 to the object person OP.

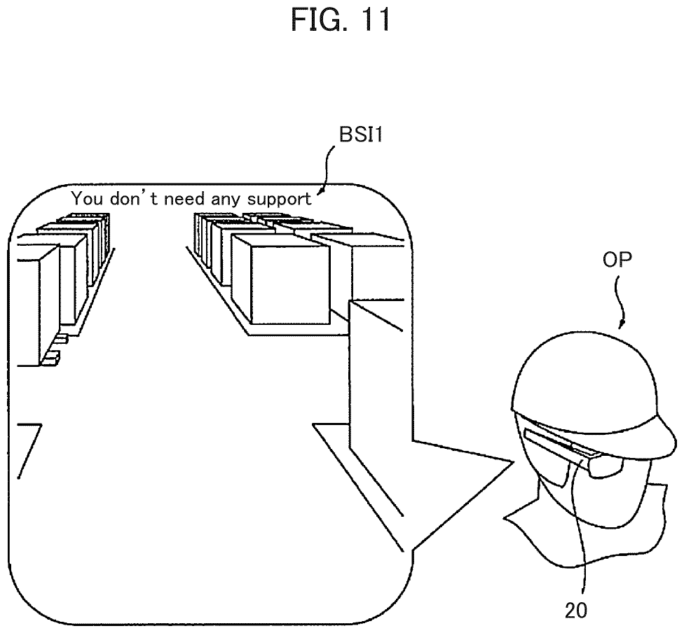

FIG. 11 is an image diagram illustrating an example of the first behavior support information BSI1 provided by the UI 20 to the object person OP. When receiving the first behavior support information BSI1 in the above-described step S61, the UI 20 displays, for example, the most simplified behavior support information BSI1 as illustrated in FIG. 11 on a display screen of the AR glasses in step S63. As described above, the first behavior support information BSI1 is, for example, information that is provided to the object person OP completely familiar with the environment E.

Therefore, in the example illustrated in FIG. 11, the behavior support information BSI1 displayed on the display screen of the UI 20 indicates only that behavior support for the object person OP is not required. When the UI 20 performs such displaying, the object person OP who has high familiarity and to whom the simplest behavior support information BSI1 is provided can recognize that the behavior support system 100 normally operates.

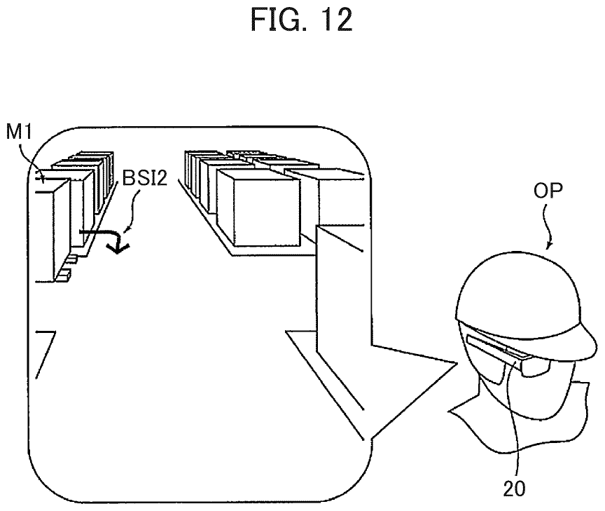

FIG. 12 is an image diagram illustrating an example of the second behavior support information BSI2 provided by the UI 20 to the object person OP. When receiving the second behavior support information BSI2 in the above-described step S61, the UI 20 displays the simplified behavior support information BSI2 on the display screen of the AR glasses in step S63 as illustrated in FIG. 12, for example. As described above, the second behavior support information BSI2 is, for example, information that is provided to the object person OP who has some experience with the environment E and is relatively familiar with the environment E. Therefore, in the example illustrated in FIG. 12, the second behavior support information BSI2 displayed on the display screen of the UI 20 is more detailed than the above-described first behavior support information BSI1 but is simplified information indicating only an arrow corresponding to the traveling direction of the autonomous machine M1.

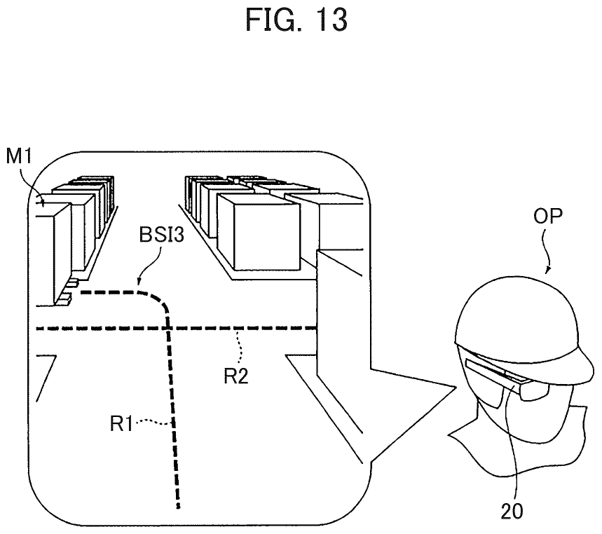

FIG. 13 is an image diagram illustrating an example of the third behavior support information BSI3 provided by the UI 20 to the object person OP. When receiving the third behavior support information BSI3 in the above-described step S61, the UI 20 displays the behavior support information BSI3 on the display screen of the AR glasses in step S63 as illustrated in FIG. 13, for example. As described above, the third behavior support information BSI3 is information that is provided to the object person OP who lacks experience with the environment E and is not very familiar with the environment E. Therefore, in the example illustrated in FIG. 13, the third behavior support information BSI 3 displayed on the display screen of the UI 20 is more detailed than the above-described second behavior support information BSI2 but is simplified information indicating only broken lines corresponding to the movement routes R1 and R2 of the autonomous machines M1 and M2.

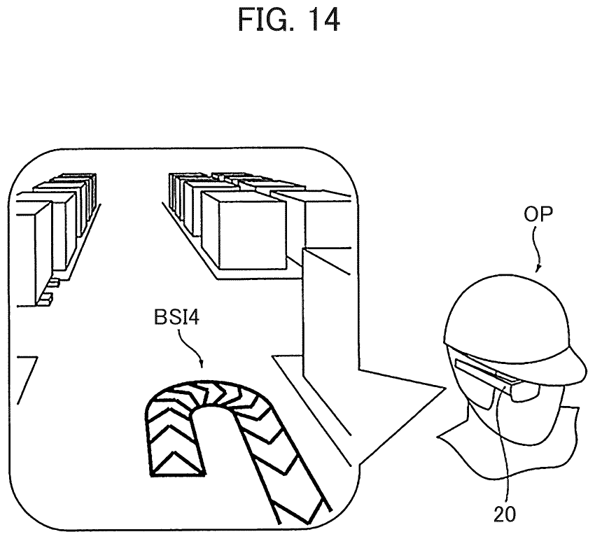

FIG. 14 is an image diagram illustrating an example of the fourth behavior support information BSI4 provided by the UI 20 to the object person OP. When receiving the fourth behavior support information BSI4 in the above-described step S61, the UI 20 displays the most detailed behavior support information BSI4 on the display screen of the AR glasses in step S63 as illustrated in FIG. 14, for example. As described above, the fourth behavior support information BSI4 is, for example, information that is provided to the object person OP who has little experience with the environment E and is not familiar with the environment E at all. Therefore, in the example illustrated in FIG. 14, the fourth behavior support information BSI4 displayed on the display screen of the UI 20 is information for directly displaying the movement route R4 corresponding to the optimal behavior OP of the object person OP.

After the UI 20 ends step S63 of providing any of the above-described behavior support information BSI1 to BSI4, the UI 20 ends step S6 illustrated in FIG. 10. Thereafter, the behavior support system 100 ends the behavior support method BSM illustrated in FIG. 4 and repeats steps S1 to S6 of the behavior support method BSM again at the predetermined interval.

As described above, the behavior support apparatus 10 according to the present embodiment is an apparatus that supports a behavior of the object person OP in accordance with the environment E around the object person OP and includes the learning unit 11, the predicting unit 12, and the behavior support unit 13. The learning unit 11 learns the environment information EI regarding the environment E and the behavior information BI regarding the behavior of the object person OP with respect to the environment E and generates the behavior model BM for the object person OP. The predicting unit 12 generates the predicted behavior PB of the object person OP based on the behavior model BM and the environment information EI. The behavior support unit 13 generates the behavior support information BSI1 to BSI4 for the object person OP in accordance with the degree of coincidence DC between the optimal behavior OB of the object person OP based on the environment information EI and the predicted behavior PB of the object person OP.

With the above-described configuration, the behavior support apparatus 10 according to the present embodiment causes the learning unit 11 to learn a behavior with respect to the environment E around each object person OP and can generate the predicted behavior PB of the object person OP with respect to the environment E around the object person OP by the predicting unit 12. In addition, the behavior support unit 13 can support a behavior in accordance with the familiarity of each object person OP with the environment E by generating the behavior support information BSI1 to BSI4 in accordance with the degree of coincidence DC between the predicted behavior PB of the object person OP and the optimal behavior OB of the object person OP.

More specifically, in the behavior support apparatus 10 according to the present embodiment, as the degree of coincidence DC between the optimal behavior OB of the object person OP and the predicted behavior PB of the object person OP decreases, the behavior support unit 13 makes the behavior support information BSI1 to BSI4 more detailed.

With this configuration, the behavior support apparatus 10 according to the present embodiment can provide the most detailed behavior support information BSI4 as illustrated in FIG. 14 to the object person OP whose degree of coincidence DC between the predicted behavior PB and the optimal behavior OB is at the lowest level and whose familiarity with the environment E is at the lowest level. Therefore, even when the object person OP has low familiarity with the environment E, the object person OP can take the optimal behavior OB in accordance with the environment E around the object person OP, and it is possible to prevent a decrease in the overall efficiency in the environment E.

In the behavior support apparatus 10 according to the present embodiment, as the degree of coincidence DC between the optimal behavior OB of the object person OP and the predicted behavior PB of the object person OP increases, the behavior support unit 13 simplifies the behavior support information BSI1 to BSI4 more.

With this configuration, the behavior support apparatus 10 according to the present embodiment can provide the more simplified behavior support information BSI3 as illustrated in FIG. 13 to the object person OP who has improved familiarity with the environment E and whose degree of coincidence DC between the predicted behavior PB and the optimal behavior OB has increased. In addition, the behavior support apparatus 10 according to the present embodiment can provide the more simplified behavior support information BSI2 as illustrated in FIG. 12 to the object person OP who has improved familiarity with the environment E and whose degree of coincidence DC between the predicted behavior PB and the optimal behavior OB has further increased.

In addition, the behavior support apparatus 10 according to the present embodiment can provide the most simplified behavior support information BSI1, such as display indicating that the target behavior support illustrated in FIG. 11 is not required, to the object person OP who is sufficiently familiar with the environment E and whose predicted behavior PB and optimal behavior OB substantially match. Therefore, it is possible to prevent the object person OP from relying excessively on the behavior support information BSI1 to BSI4 and to efficiently improve the autonomy and familiarity of the object person OP. As a result, when a failure occurs in the behavior support apparatus 10, the object person OP can take an appropriate behavior in accordance with the environment E around the object person OP, and it is possible to prevent a decrease in the overall efficiency in the environment E.

In addition, as described above, in the behavior support apparatus 10 according to the present embodiment, in a case where the degree of coincidence DC of the optimal behavior OB and the predicted behavior PB of the object person OP exceeds the predetermined threshold, the behavior support unit 13 may not generate the behavior support information BSI1 to BSI4. Even with this configuration, the behavior support apparatus 10 according to the present embodiment can prevent the object person OP from relying excessively on the behavior support information BSI1 to BSI4 and efficiently improve the autonomy and familiarity of the object person OP. As a result, when a failure occurs in the behavior support apparatus 10, the target person OP can take an appropriate behavior in accordance with the environment E around the target person OP, and it is possible to prevent a decrease in the overall efficiency in the environment E.

In the behavior support apparatus 10 according to the present embodiment, as the degree of coincidence DC between the optical behavior OB of the object person OP and the predicted behavior PB of the object person OP decreases, the behavior support unit 13 may simplify the behavior support information BSI1 to BSI4 more, contrary to the example described above. Even with this configuration, the behavior support apparatus 10 according to the present embodiment can prevent the object person OP from relying excessively on the behavior support information BSI1 to BSI4 and efficiently improve the autonomy and familiarity of the object person OP. As a result, when a failure occurs in the behavior support apparatus 10, the object person OP can take an appropriate behavior in accordance with the environment E around the object person OP, and it is possible to prevent a decrease in the overall efficiency in the environment E.

In addition, the behavior support system 100 according to the present embodiment includes the above-described behavior support apparatus 10 and the user interface (UI 20) that provides the behavior support information BSI1 to BSI4 generated by the behavior support apparatus 10 to the object person OP. Therefore, the behavior support system 100 according to the present embodiment can not only produce the same effects as those of the above-described behavior support apparatus 10 but also efficiently provide the behavior support information BSI1 to BSI4 to the object person OP by the UI 20.

In addition, as described above, the behavior support method BSM according to the present embodiment is a method of supporting a behavior of the object person OP in accordance with the environment E around the object person OP. The behavior support method BSM includes step S3 of learning the environment information EI regarding the environment E and the behavior information BI regarding the behavior of the object person OP with respect to the environment E by machine learning, and generating the behavior model BM for the object person OP. The behavior support method BSM further includes step S4 of generating the predicted behavior PB of the object person OP based on the behavior model BM and the environment information EI and step S5 of generating the behavior support information BSI1 to BSI4 for the object person OP in accordance with the degree of coincidence DC between the optimal behavior OB of the object person OP based on the environment information EI and the predicted behavior PB of the object person OP. The behavior support method BSM further includes step S6 of providing the behavior support information BSI1 to BSI4 to the object person OP. With this configuration, the behavior support method BSM according to the present embodiment can produce the same effects as those of the above-described behavior support apparatus 10 and the behavior support system 100.

Although the embodiments of the behavior support apparatus, the behavior support system, and the behavior support method according to the present disclosure are described in detail with reference to the drawings, the specific configurations are not limited to the embodiments, and even when changes are made in the design without departing from the gist of the present disclosure, those changes are included in the present disclosure.

### REFERENCE SIGNS LIST

10: behavior support apparatus
11: learning unit
12: predicting unit
13: behavior support unit
20: UI (user interface)
100: behavior support system
BI: behavior information
BM: behavior model
BSI1: behavior support information
BSI2: behavior support information
BSI3: behavior support information
BSI4: behavior support information
BSM: behavior support method
DC: degree of coincidence
E: environment
EI: environment information
OB: optimal behavior
OP: object person
PB: predicted behavior

1. A behavior support apparatus that supports a behavior of an object person in accordance with an environment around the object person, the behavior support apparatus comprising:
a learning unit that learns environment information regarding the environment and behavior information regarding a behavior of the object person with respect to the environment and generates a behavior model for the object person;
a predicting unit that generates a predicted behavior of the object person based on the behavior model and the environment information; and
a behavior support unit that generates behavior support information for the object person in accordance with a degree of coincidence between an optimal behavior of the object person based on the environment information and the predicted behavior of the object person.

2. The behavior support apparatus according to claim 1, wherein
as the degree of coincidence between the optimal behavior of the object person and the predicted behavior of the object person increases, the behavior support unit simplifies the behavior support information more.

3. The behavior support apparatus according to claim 1, wherein
as the degree of coincidence between the optimal behavior of the object person and the predicted behavior of the object person decreases, the behavior support unit makes the behavior support information more detailed.

4. The behavior support apparatus according to claim 1, wherein
when the degree of coincidence between the optimal behavior of the object person and the predicted behavior of the object person exceeds a predetermined threshold, the behavior support unit does not generate the behavior support information.

5. The behavior support apparatus according to claim 1, wherein
as the degree of coincidence between the optimal behavior of the object person and the predicted behavior of the object person decreases, the behavior support unit simplifies the behavior support information more.

6. A behavior support system comprising:
the behavior support apparatus according to claim 1; and
a user interface that provides the behavior support information generated by the behavior support apparatus to the object person.

7. A behavior support method of supporting a behavior of an object person in accordance with an environment around the object person, the behavior support method comprising:
learning environment information regarding the environment and behavior information regarding a behavior of the object person with respect to the environment by machine learning and generating a behavior model for the object person;
generating a predicted behavior of the object person based on the behavior model and the environment information;
generating behavior support information for the object person in accordance with a degree of coincidence between an optimal behavior of the object person based on the environment information and the predicted behavior of the object person; and
providing the behavior support information to the object person.
